(19) United States
(12) Patent Application Publication
(10) Pub. No.: US 2014/0278234 A1
(43) Pub. Date: Sep. 18, 2014

(54) METHOD AND A SYSTEM FOR A STATISTICAL EQUIVALENCE TEST

(71) Applicant: SAMSUNG ELECTRONICS CO., LTD., Gyeonggi-do (KR)

(72) Inventors: In-Kap CHANG, Gyeonggi-do (KR); Seung-Hoon TONG, Seoul (KR); Soo-Hyuck CHOI, Gyeonggi-do (KR)

(73) Assignee: SAMSUNG ELECTRONICS CO., LTD., Gyeonggi-do (KR)

(21) Appl. No.: 14/188,952

(22) Filed: Feb. 25, 2014

(30) Foreign Application Priority Data
Mar. 15, 2013 (KR) 10-2013-0028191

(51) Int. Cl. G06F 17/18

(52) U.S. Cl. CPC G06F 17/18
USPC 702/179

(57) ABSTRACT

A method of performing a statistical equivalence test including first deciding if process data has equivalence, non-equivalence or improvement by comparing a statistical value of the process data with a criteria statistical value, correcting the criteria statistical value using a statistical tolerance for the process data that has the non-equivalence or improvement, and second deciding if the process data that has the non-equivalence or improvement has acceptance or non-equivalence by comparing the process data that has the non-equivalence or improvement with the corrected criteria statistical value.

### CROSS-REFERENCE TO RELATED APPLICATION

This application claims priority under 35 U.S.C. §119 to Korean Patent Application No. 10-2013-0028191 filed on Mar. 15, 2013 in the Korean Intellectual Property Office (KIPO), the disclosure of which is incorporated by reference herein in its entirety.

### BACKGROUND

1. Technical Field

The inventive concept relates to a method of testing equivalence. More particularly, the inventive concept relates to a method of testing statistical equivalence in consideration of process data characteristics in a monitoring system for a semiconductor fabrication process.

2. Discussion of the Related Art

Tests of equivalence have been studied and utilized in statistics fields. However, an engineer may not be able to determine and analyze an optimal model in real time according to data characteristics, an outlier or a data distribution when utilizing tests of equivalence in practice.

For example, since data generated in a semiconductor industry have various distributions or characteristics according to a data format or a collection object, it is limited to analyze the data with one or two specific statistical models.

Further, haunting issues, which are not solved through a statistical outlier logic scheme, may exist in the process data. For example, an outlier may not be effectively removed by an inter quartile range (IQR) scheme due to the data distribution. In addition, the outlier may not be removed from the process data by a general primary outlier logic scheme since the unit of process data used in measuring a lot and a wafer is different from the unit of process data used in moving.

Further, a semiconductor data analysis engineer other than a statistical expert may not be able to select an optimal scheme and analyze data from a data preprocess to a statistical logic application in real time. Further, even the statistical expert may spend a lot of time and resources to find an optimal statistical logic by analyzing the data processing.

### SUMMARY

Exemplary embodiments of the inventive concept provide a method and a system of testing statistical equivalence which can determine optimal equivalence in consideration of a statistical tolerance.

Exemplary embodiments of the inventive concept provide a method and a system of testing statistical equivalence which can utilize an experiential technical tolerance of a process engineer by objectifying the experiential technical tolerance.

According to an exemplary embodiment of the inventive concept, a method of performing a statistical equivalence test includes first deciding if process data has equivalence, non-equivalence or improvement by comparing a statistical value of the process data with a criteria statistical value, correcting the criteria statistical value using a statistical tolerance for the process data that has the non-equivalence or improvement, and second deciding if the process data that has the non-equivalence or improvement has acceptance or non-equivalence by comparing the process data that has the non-equivalence or improvement with the corrected criteria statistical value.

In an exemplary embodiment of the inventive concept, the corrected criteria statistical value for the process data with the non-equivalence may be obtained by following equations;

$${Criteria}_{Avg \text{-} non} = \frac{Max [ {\{ CI of ( {X}_{R} - {X}_{C \text{-} non} ) \}}^{2} ]}{Min ( {σ}_{R}^{2} , {σ}_{C \text{-} non}^{2} )}$$

$${Criteria}_{Var \text{-} non} = \frac{Max ( {σ}_{R}^{2} , {σ}_{C \text{-} non}^{2} )}{Min ( {σ}_{R}^{2} , {σ}_{C \text{-} non}^{2} )}$$

where, CI denotes a confidence interval, X_{R} is an average value of a reference process data group, X_{C-nom} is an average value of a non-equivalence decided process data group, σ_{R}² of is a standard deviation of the reference process data group, and σ_{C-nom}² is a standard deviation of the non-equivalence decided process data group.

In an exemplary embodiment of the inventive concept, the corrected criteria statistical value for the process data with the improvement may be obtained by following equations;

$${Criteria}_{Avg \text{-} imp} = \frac{Max [ {\{ CI of ( {X}_{R} - {X}_{C \text{-} imp} ) \}}^{2} ]}{{σ}_{R}^{2}}$$

$${Criteria}_{Var \text{-} imp} = \frac{{σ}_{C \text{-} imp}^{2}}{{σ}_{R}^{2}}$$

where, CI denotes a confidence interval, X_{R} is an average value of a reference process data group, X_{C-imp} is an average value of an improvement decided process data group, and σ_{C-imp}² is a standard deviation of the improvement decided process data group.

In an exemplary embodiment of the inventive concept, the method may further include third deciding if the process data that has the non-equivalence after the second deciding has acceptance or non-equivalence using an experiential technical tolerance of an engineer, and fourth deciding final equivalence of the process data based on the first to third decision results.

In an exemplary embodiment of the inventive concept, the process data may be normal distribution/non-normal distribution, bounded data distribution/unbounded data distribution or a censored data distribution.

The statistical value of the process data may be calculated according the data distribution.

The calculated statistical value may be tested through an inference estimation scheme.

In an exemplary embodiment of the inventive concept, the process data may have improvement under the following conditions:

a) if the statistical value of the non-equivalence decided process data is closer to a target value than to the criteria statistical value, b) if the statistical value of the non-equivalence decided process data is less than the criteria statistical value when a smaller statistical value of the non-equivalence decided process data is better, or c) if the statistical value of the non-equivalence decided process data is greater than the criteria statistical value when a greater statistical value of the non-equivalence decided process data is better.

In an exemplary embodiment of the inventive concept, the process data may be collected in a database according to a process variable.

The collected process data may be filtered for equivalence, consistency and traceability.

The filtered process data may be classified according to data characteristics.

The data characteristics may include quantification/attribute, real number/integer/percentage or row/summary.

The classified process data may be modeled in a statistical process model to remove abnormal values from the classified process data.

According to an exemplary embodiment of the inventive concept, a system for testing statistical equivalence includes a storing unit, an input unit, and a decision unit. The storing unit stores a reference statistical value according to a process variable and data characteristics and engineer experience information. The input unit receives process data from at least one process equipment. The decision unit determines statistical equivalence by comparing the received process data with the reference statistical value by: first deciding if the received process data has equivalence, non-equivalence or improvement by comparing statistics of the received process data with reference statistics; correcting the reference statistics using a statistical tolerance for the process data that has the non-equivalence or improvement; second deciding if the process data that has the non-equivalence or improvement has acceptance or non-equivalence by comparing the process data that has the non-equivalence or improvement with the corrected reference statistics; third deciding if the process data that has the non-equivalence after the second deciding has acceptance or non-equivalence using an experiential technical tolerance of an engineer; and fourth deciding final equivalence of the process data based on the first to third decision results.

In an exemplary embodiment of the inventive concept, the input unit collects and filters the received process data according to the process variable, classifies the received process data according to the data characteristics, and models the received process data on a statistical process model to remove abnormal values from the classified process data.

According to an exemplary embodiment of the inventive concept, a method of performing a statistical equivalence test includes first determining if process data has non-equivalence or improvement based on a comparison of a statistical value of the process data to a statistical value of reference data; adjusting the statistical value of the reference data; and second determining if the process data has non-equivalence by comparing the process data with non-equivalence or improvement to the adjusted statistical value of the reference data.

The process data is first determined to have non-equivalence when midranges of the process data and the reference data are not identical to each other, or a dispersion range of the process data is greater than that of the reference data.

The process data is second determined to have non-equivalence when the midrange of the process data and adjusted midrange of the adjusted reference data are not identical to each other, or the dispersion range of the process data is not equivalent to that of the adjusted reference data.

The method may further include third determining whether to admit the process data as equivalence or to process the process data as non-equivalence using an experiential and technical tolerance.

The first to third determinings may be automatically made.

### BRIEF DESCRIPTION OF THE DRAWINGS

The above and other features of the inventive concept will become more apparent by describing in detail exemplary embodiments thereof with reference to the accompanying drawings in which:

FIG. 1 is a block diagram illustrating a process monitoring system employing a scheme of testing statistical equivalence according to an exemplary embodiment of the inventive concept;

FIG. 2 is a block diagram illustrating a statistical equivalence test system of FIG. 1, according to an exemplary embodiment of the inventive concept;

FIG. 3 is a view illustrating an equivalence test according to an exemplary embodiment of the inventive concept;

FIG. 4 is a flowchart illustrating a method of testing statistical equivalence according to an exemplary embodiment of the inventive concept; and

FIG. 5 is a flowchart illustrating a process of testing statistical equivalence of FIG. 4, according to an exemplary embodiment of the inventive concept.

### DETAILED DESCRIPTION OF THE EMBODIMENTS

Exemplary embodiments of the inventive concept will be described more fully hereinafter with reference to the accompanying drawings. This inventive concept may, however, be embodied in many different forms and should not be construed as limited to the embodiments set forth herein. Like reference numerals may refer to like elements throughout this application.

It will be understood that when an element is referred to as being “connected” or “coupled” to another element, it can be directly connected or coupled to the other element or intervening elements may be present.

As used herein, the singular forms “a,” “an” and “the” are intended to include the plural forms as well, unless the context clearly indicates otherwise.

FIG. 1 is a block diagram illustrating a process monitoring system 100 employing a scheme of testing statistical equivalence according to an exemplary embodiment of the inventive concept.

Referring to FIG. 1, the process monitoring system 100 includes a process monitoring apparatus 110 combined with at least one process machine 102 and least one process controller 104 through data communication links 106. The process monitoring apparatus 110 may be combined with an engineer terminal 120. The process monitoring system 100 may include all process machines 102 on a production line.

In an exemplary embodiment of the inventive concept, each process machine 102 may include a semiconductor fabricating machine, such as an etching machine, a deposition machine, a photo machine or an ion-injection machine, for fabricating semiconductor devices. Each process machine 102 may include multiple sensors to monitor processes executed in the process machines 102. Sensors, which are included in the process machines, include temperature sensors, pressure sensors, flow sensors, or arbitrary sensors to monitor physical conditions of a fabrication process or physical characteristics of a semiconductor work-piece fabricated through the process machines 102.

Each fabrication process, which is performed by the process machines 102, is characterized by various physical conditions and characteristics measured through sensors and various operation parameters that are generally referred to as process data. Each individual physical condition or characteristics measured through sensors and each operation parameter may be individual process variables of process data.

The sensors, the process machines 102 and the process controllers 104 may be monitored to collect process variables at continuous time points during a process.

In an exemplary embodiment of the inventive concept, each process variable is applied to a specific process. Sensor measured values and operation parameters in various steps of a process signify individual process variables.

The process controllers 104 control the operation parameters of the process machines 102. For example, the process controllers 104 may control chamber temperature, vacuum pumps and gas-injection systems. The process controllers 102 may store at least one process recipe. Each process recipe may define operation parameters of the process machine 102 in each step. In an exemplary embodiment of the inventive concept, the process recipes may be loaded on the process machines 102 by the process controllers 104.

The data communication links 106 may include communication links of the related art and may be wire or wireless links. Data may be transmitted in a raw or processed format between the process machines 102, the process controllers 104 and the process monitoring apparatus 110. In an exemplary embodiment of the inventive concept, a semiconductor equipment communication standard (SECS) interface is used. In an exemplary embodiment of the inventive concept, a generic model for communication and control, such as a generic equipment manager (GEM) interface, an SECS/GEM interface or a high-speed SECS message service (HSMS) interface may be used.

The process monitoring apparatus 110 may be a single server for analyzing process data input from the process machines 102 and the process controllers 104. The process monitoring apparatus 110 may include multiple servers and/or computers. In an exemplary embodiment of the inventive concept, the process monitoring apparatus 110 includes a statistical equivalence test system 112 according to an exemplary embodiment of the inventive concept.

The statistical equivalence test system 112 is combined with the engineer terminal 120 to communicate with each other. Information is exchanged between the statistical equivalence test system 112 and the engineer terminal 120 to perform an equivalence test process in the statistical equivalence test system 112 in consideration of an engineer technical tolerance. The decision information of process engineers is quantified into equivalence/non-equivalence/improvement classes and builds a database of equivalence decision reference values which are objectified through a statistical process of quantified technical decision results.

FIG. 2 is a block diagram illustrating the statistical equivalence test system 112 of FIG. 1, according to an exemplary embodiment of the inventive concept.

The statistical equivalence test system 112 includes a data pre-processing unit 112a, a statistics calculation unit 112b, an equivalence decision unit 112c, a reporter 112d and a storage unit 112e. The storage unit 112e includes a process measurement database 112f, an outlier logic model 112g, a statistics database 112h, and engineer technical information 112i.

The data pre-processing unit 112a establishes reference information about the collected process data according to a process variable and filters the collected process data to ensure equivalence, accuracy and traceability. In addition, the data pre-processing unit 112a hierarchically classifies the collected process data according to data characteristics and types and stores the collected process data in the process measurement database 112f in a statistical data structure.

Further, the data pre-processing unit 112a applies a suitable outlier logic model 112g according to the data characteristics, type and hierarchical structure of the process data such that an outlier is removed from the process data and builds a specimen for statistical analysis.

The statistics calculation unit 112b decides a data distribution of a specimen data group from which the outlier is removed and calculates a midrange and a dispersion of a data distribution. Statistical values of the calculated midrange and dispersion are stored in the statistics database 112h through a test process according to an inference test scheme. The accumulated statistical values may be provided as process reference statistical values.

The equivalence decision unit 112c compares the process reference statistical values built in the statistics database 112h with the statistical values calculated from the process data to test equivalence of the process data. According to an exemplary embodiment of the inventive concept, primary, secondary and tertiary equivalence tests may be performed so that an occurrence rate of non-equivalence may be minimized.

The reporter 112d generates equivalence test reports showing an equivalence test result. The equivalence test report may be transmitted to at least one client which is networked to the process monitoring apparatus 110 and the engineer terminal 120 (for example, local computers, remote computers, personal digital assistants (PDAs), pagers and portable cellular telephones). Further, the reporter 112d may cause the process machines 102 to be shut down, may cause a machine to generate a warning or may cause other such steps.

The storage unit 112e may include the process measurement database 112f, the outlier logic model 112g, the statistics database 112h, and the engineer technical information 112i. In an exemplary embodiment of the inventive concept, the storage unit 112e is a single storage device of a computer or a server of the statistical equivalence test system 112. The storage unit 112e may exist at an outside of the statistical equivalence test system 112. In an exemplary embodiment of the inventive concept, the storage unit 112e may include multiple storage devices, some of which include redundant copies of data for a data backup.

Process measurement data (e.g., process data) may be stored in the process measurement database 112f. The stored process measurement data may be utilized to show deviations and transitions of the process machines 102 while processes are being performed in the process machines 102. In an exemplary embodiment of the inventive concept, the stored process measurement data are used to calculate the statistical values for the equivalence test.

The process measurement data are stored in the process measurement database 112f according to process variations such as an analysis subject, an analysis time period, an analysis item, an analysis unit and an analysis number.

For example, the analysis subject may include an equivalent-product diffusion analysis between/in lines, an abnormal-detection monitoring analysis between/in equipments, an equivalence test analysis before/after a change (e.g., including all changes caused in an entire process of fabricating a semiconductor such as a process change, an equipment change or a material change) and a quality analysis of a new product or diffusion products. The analysis time period may be set to ensure the equivalence between a reference data group defined for performing the equivalence test and a comparative data group. When an amount of data collected during a first set analysis time period is short, the analysis time period may extend to ensure similar equivalence characteristics. The analysis item may be based on summary data generated by processing all measurement/test data or raw data generated through all processes. For example, the analysis item may include fabrication process (FAB) measurement data, equipment signal data, electrical die sorting (EDS)/package (PKG) test data, yield data and BIN data. The analysis unit may be defined to ensure traceability in the minimum unit that may be generated from the entire semiconductor process. For example, the minimum unit may include a lot, a cassette, a wafer, a chip and a module. The analysis number may include an additional analysis number designated according to accumulation of a sample number to improve statistical consistency.

Further, the process measurement data are filtered to ensure the data equivalence, and the consistency and traceability of the raw data.

For example, when chip data of a wafer level processed in FAB-EDS constitutes a new lot in PKG so that chips of mutually different wafers are mixed, the data are reprocessed based on FAB or EDS and the data causing a data distortion are removed to allow the analysis subject to have statistical and technical meanings when the analysis subject is a variation point generated from FAB or EDS. The data may be removed due to an error as follows. When the chip number in the wafer is 300, 5 chips are tested by issuing a PKG test time. When one chip has failed, the yield of the corresponding wafer may be displayed as 80%.

Further, the process measurement data may include, for example, quantitative and attribute data, real number, integer and percentage data, raw data and summary data according to data types.

For example, the quantitative data includes critical dimension (CD)/thickness (THK) data obtained by a FAB measurement output, and homograde data includes yield data obtained by a good/bad decision, bin data and discrete data such as a particle/defect number. The real number data include CD/THK data. The integer data include the number of fail bits and the number of particles. The percentage data include the yield data which are the summary data according to a good/bad result and bin data.

The raw data include the FAB measurement data and chip unit good/bad data. The summary data include the yield data and wafer average data, such as average/median/sum, which are obtained by primarily processing the raw data or other data.

The outlier logic model 112g applies a suitable abnormal value for removing logic according to data characteristics. The outlier logic scheme includes a statistical outlier logic scheme and a technical outlier logic scheme.

The statistical outlier scheme includes an inter quartile range (IQR) scheme, a Carling's modification scheme and a skewed Carling's modulation scheme. The statistical outlier scheme is an abnormal value removing scheme that considers the number of data samples and the distribution type of the data samples. The technical outlier scheme is a scheme of forcibly removing data generated by a reset and a measurement error.

Further, the outlier logic scheme may include a normal-the-best scheme, a smaller-the-better scheme and a longer-the-better scheme. For example, there exists a Carling's modification scheme as the normal-the-best scheme. In addition, there exists a haunting removal scheme as the smaller-the-better scheme and the longer-the-better scheme. The haunting removal scheme is a scheme of removing only the limited number of data by arranging data in size order or a scheme of sequentially removing data which are haunted at a predetermined reference value or more.

Further, the outlier logic may include a within scheme in which data is applied after constructing the data in a matrix structure, a between scheme and a hybrid scheme.

For example, the outlier is removed based on the measurement data of a wafer in the within scheme. In the between scheme, the outlier between wafers is removed based on an average of the measurement data of the wafers. The hybrid scheme is a mixing scheme of the two schemes, e.g., within and between. When data exists in a hierarchical structure of a site, a wafer and a lot, the outlier logic is applicable step by step.

The statistics database 112h includes a midrange and a dispersion according to the distribution of the sample data group which is obtained by removing an outlier from the process measurement data.

The data distribution includes normal and non-normal distributions (e.g., including symmetry and asymmetry). For example, the FAB measurement data in which specification (SPEC) exists have normal distribution characteristics. The data having skew/kurtosis characteristics such as electrical test (ET) measurement data has abnormal distribution characteristics. A scheme of testing the normal distribution may include the D'Agostino-Pearson Omnibus test, Jarque-Bera test, Anderson Darling test, Kolomogorov-Smirnov test and Shapiro-Wilcoxon test.

Further, the data distribution may include a bounded/unbounded data distribution. The bounded data may include percentage data such as a yield and bin. The unbounded data may include the number of fail bits and FAB measurement data. For example, the EDS yield data may be analyzed by using the unbounded data distribution after Log Odds conversion and may be analyzed by using a censored data distribution. After removing fail data from EDS/PKG, the data structure in which yield and bin values are concentrated at 100% or 0% is decided as the censored data distribution.

The midrange and dispersion which are statistical values are differently calculated depending on the decided data distribution from the statistic values stored in the statistics database 112h.

For example, if the data distribution is a normal distribution, the arithmetic mean and the standard deviation are calculated as the midrange and dispersion. If the data distribution is a non-normal symmetrical distribution, trimmed mean and percentage band Midvariance are calculated as the midrange and dispersion. If the data distribution is an abnormal asymmetrical distribution, M-estimator (e.g., Robust mean) and percentage band Midvariance are calculated as the midrange and dispersion. If the data distribution is a censored data distribution, an average and a dispersion which are amended based on a truncated normal distribution are calculated as the midrange and dispersion.

For example, in a case of FAB measurement data, the statistical values are calculated based on the reference data distribution, and in the case of ET data, the statistical values are calculated according to an individual distribution of the reference/comparative data. The dispersion is calculated in consideration of a data structure (e.g., a matrix or column) through a pooled standard deviation scheme (e.g., a calculation scheme which is utilized in a 2-sample T-test is applied).

The statistical value stored in the statistics database 112h is tested through an inferential test scheme.

For example, a significant difference of the midrange is decided through the 2-sample T-test scheme. The Mann-Whitney U test, Siegel-Tukey test, Kolomogorov-Smirnov test, Moses test, Chi-square test, Wilcoxon Signed Ranks test or Paired T test which is similar to the 2-sample T-test scheme may be used for the decision. Since the reference data group exists, the equivalence test scheme may perform the improvement decision when a target exists. The dispersion test is performed through an F-test scheme.

When the engineer technical information 112i is decided as non-equivalence even though the statistical tolerance is taken into consideration, the engineer technical information 112i is decided to be accumulated as equivalence in the experiential technical tolerance of process engineers and includes the decision result data.

If these decision result data are quantified into the equivalence/non-equivalence/improvement classes and are accumulated by the statistical process of the quantified technical decision results to be objectified, the decision result data may include information built in a computer file as objective decision information unified into one.

The engineer technical information 112i may be referenced in the equivalence test process in consideration of a technical tolerance. Thus, the engineer's experience decision is quantized according to equivalence/non-equivalence/improvement and the statistical data of the quantized technical decision results are built into a database such as a computer file, so that the equivalence test process considering the engineer technical tolerance may be automated.

FIG. 3 is a view illustrating an equivalence test according to an exemplary embodiment of the inventive concept.

Referring FIG. 3, a equivalence test method may minimize non-equivalence decisions through a first step S210 of performing a statistical hypothesis test scheme, a second step S220 of performing a statistical tolerance considering test scheme, and a third step S230 of performing a technical tolerance considering test scheme.

In other words, in step S212, if midranges of comparative data and reference data are identical to each other and a dispersion range of the comparative data are equal to or narrower than that of the reference data, it is determined that the comparative data are identical to the reference data. In other words, there is equivalence.

In step S214, if the midranges of the comparative data and the reference data are not identical to each other or the dispersion range of the comparative data are greater than that of the reference data, it is determined that the comparative data are not identical to the reference data. In other words, there is non-equivalence.

In step S216, if a statistical value of the comparative data corresponds to one of the following conditions:

a) the statistical value of the comparative data (e.g., the non-equivalence decided process data) is placed at a position more close to a target value than to a reference statistical value,

b) the statistical value of the comparative data (e.g., the non-equivalence decided process data) is less than the reference statistical value in a case that the smaller statistical value of the non-equivalence process data is the better statistical value of the non-equivalence process data, or

c) the statistical value of the comparative data (e.g., the non-equivalence decided process data) is greater than the reference statistical value in a case that the greater statistical value of the non-equivalence process data is the better statistical value of the non-equivalence process data. Then, the statistical value of the comparative data (e.g., the non-equivalence decided process data) is determined as improvement.

Before performing the second step S220, the reference statistical value (which may hereinafter be referred to as criteria statistical value) is corrected as follows:

The corrected criteria statistical value for the non-equivalence, in other words, a criteria average value Criteria_{Avg-nom} and a criteria distribution Criteria_{Var-nom} are obtained through the following Equation 1 and Equation 2.

$$\begin{matrix}{Criteria}_{Avg \text{-} non} = \frac{Max [ {\{ CI of ( {X}_{R} - {X}_{C \text{-} non} ) \}}^{2} ]}{Min ( {σ}_{R}^{2} , {σ}_{C \text{-} non}^{2} )} & [ Equation 1 ] \\ {Criteria}_{Var \text{-} non} = \frac{Max ( {σ}_{R}^{2} , {σ}_{C \text{-} non}^{2} )}{Min ( {σ}_{R}^{2} , {σ}_{C \text{-} non}^{2} )} & [ Equation 2 ]\end{matrix}$$

wherein CI denotes a confidence interval, X_{R} is an average value of a criteria process data group, X_{C-nom} is an average value of a non-equivalence decided process data group, σ_{R}² is a standard deviation of the criteria process data group, and σ_{C-nom}² is a standard deviation of the non-equivalence decided process data group. The non-equivalence value may be managed as Criteriaₙₒₘ=Criteria_{Avg-nom}+Criteria_{Var-nom}.

Further, the adjusted criteria statistical value for supplementing a portion, the criteria statistical value of which is overestimated, in other words, the criteria average value Criteria_{Avg-imp} and the criteria distribution Criteria_{Var-imp} are obtained through following Equation 3 and Equation 4, respectively:

$$\begin{matrix}{Criteria}_{Avg \text{-} imp} = \frac{Max [ {\{ CI of ( {X}_{R} - {X}_{C \text{-} imp} ) \}}^{2} ]}{{σ}_{R}^{2}} & [ Equation 3 ] \\ {Criteria}_{Var \text{-} imp} = \frac{{σ}_{C \text{-} imp}^{2}}{{σ}_{R}^{2}} & [ Equation 4 ]\end{matrix}$$

wherein X_{C-imp} is an average value of an improvement decided process data group, and σ_{C-imp}² is a standard deviation of the improvement decided process data.

In other words, in step S222, if the midrange of the comparative data is equal to the adjusted midrange of the criteria data and the dispersion range of the comparative data is equal to or narrower than the adjusted dispersion range, it is determined that the comparative data are identical to the criteria data.

However, in step S224, if the midrange of the comparative data and the adjusted midrange of the criteria data are not identical to each other or the dispersion range of the comparative data are greater than that of the criteria data, it is decided that the comparative data are not equivalent to that of the adjusted criteria data.

After performing the system automatic decision process through the first and second steps S210 and S220 as described above, the result is reported to a process engineer in the third step S230. In steps in S232 and S234, the process engineer decides whether to admit the data as equivalence or to process the data as non-equivalence in consideration of an experiential and technical tolerance. If these decisions are accumulated to arrive at a statistical objectification level, the accumulated decisions are built as a database so that the decision is automatically performed by a computer.

FIG. 4 is a flowchart illustrating a method of testing statistical equivalence according to an exemplary embodiment of the inventive concept. FIG. 5 is a flowchart illustrating in a process of testing statistical equivalence of FIG. 4, according to an exemplary embodiment of the inventive concept.

Referring to FIGS. 4 and 5, the equivalence test method according to an exemplary embodiment of the inventive concept may be performed by a process logic which may include a hardware (for example, a circuit, an exclusive logic, a programmable logic, a microcode, etc.), a software (for example, instructions executed in a process apparatus) or a combination thereof. In an exemplary embodiment of the inventive concept, the statistical equivalence test method is performed through the statistical equivalence test system 112 of FIG. 1.

In step S302, process data may be collected from all process equipment 102 through the data pre-processing unit 112a of the statistical equivalence test system 112. In step S304, the process data collected by the data pre-processing unit 112a are hierarchically defined and filtered according process variables. In step S306, the data pre-processing unit 112a classifies the process data according to data characteristics and types. In step S308, the classified process data are sampled through a process of removing an outlier to statistically process the classified process data. The data preprocessed through the data pre-processing unit 112a are stored in the process measurement database 112f.

In step S310, the statistics calculation unit 112b decides the data distribution sampled according to the process variables and process data characteristics. In step S312, the statistics calculation unit 112b calculates a midrange and a dispersion, which are statistical, from the decision data distribution. In step S314, the statistics calculation unit 112b performs a process of testing the calculated midrange and dispersion. The statistics calculation unit 112b stores the statistical value, the test of which is completed, in the statistics database 112h.

In step S316, the equivalence decision unit 112c compares the calculated statistical value with the criteria statistical value to perform the three stage equivalence decision algorithm depicted in FIG. 5 so that the equivalence is decided.

Referring to FIG. 5, in step S316a, the equivalence decision unit 112c performs the equivalence decision through the first step of the statistical hypothesis test scheme. If non-equivalence is decided as the equivalence decision in step 316a, the equivalence decision unit 112c performs the improvement decision to decide whether the data conforms to three conditions in step S316. If the improvement is decided as the decision result in step S316b, the equivalence decision unit 112c improves the dispersion in step S316c.

When the comparative data is decided as the non-equivalence in step S316b, the criteria statistical values such as the midrange and dispersion used in the first step by equations 1 and 2, are adjusted in step S316d. When the comparative data are decided as midrange non-equivalence/dispersion improvement in step S316c, the criteria statistical values, such as the midrange and distribution used in the first step by equations 3 and 4, are adjusted in step S316d to complement an error of overestimating criteria values through the statistical equations even though a practical trend difference is low when σ_{C-nom}² in Min (σₖ²,σ_{C-nom}²), which is a denominator of the equations 1 and 2, is too small due to the dispersion improvement effect. In step 316e, the secondary equivalence decision is performed based on the adjusted criteria value calculated in step S316d for the process data primarily decided as the non-equivalence or dispersion improvement. If the comparative data is decided as accommodation in step S316e, the comparative data is processed as equivalence. To the contrary, if the comparative data is decided as non-equivalence in step S316e, the secondary non-equivalence decision result is transmitted to the process engineer terminal 120. In step S316f, the process engineer inputs accommodation or non-equivalence decision data through the terminal by himself. The input of tertiary equivalence data are stored in the storage unit 112 as the engineer technical information 112i.

In step S316, the equivalence decision unit 112c unifies the primary, secondary and tertiary equivalence decision results into one such that it is decided overall and finally whether the comparative data is equivalent to the criteria data.

As the analysis result of using the data generated from a semiconductor fabrication line, since the accuracy (e.g., a non-equivalence incidence of about 1%) of an exemplary embodiment of the inventive concept is greater than that (e.g., a non-equivalence incidence of about 30˜80%) of the related art, an exemplary embodiment of the inventive concept may be utilized to perform upward equalization and standardization between lines and to early detect an abnormality or variation caused in a semiconductor process. Further, an exemplary embodiment of the inventive concept may be utilized as a core engine of process/equipment and a system for detecting an abnormality in units of lines. In addition, an exemplary embodiment of the inventive concept may contribute to upward standardization and may be usable between/in lines, between/in equipment, before/after a variation point, for a process, and a system for detecting a test abnormality and monitoring. Further, an exemplary embodiment of the inventive concept may provide objective abnormal decision criteria to the exclusion of a subjective decision difference between engineers. Thus, unnecessary engineer analysis loss may be reduced.

An exemplary embodiment of the inventive concept may be expansively employed in all industry fields including those involving production of a display, an optical device and a solar cell as well as semiconductor production.

Further, the method of testing statistical equivalence according to exemplary embodiments of the inventive concept can perform optimal failure detection and a monitoring in one integrated system according to various types, distributions and characteristics of data generated from a semiconductor process. For example, the equivalence test scheme is optimized to be suitable for the semiconductor industry, so that unnecessary loss of engineers may be reduced. In addition, instead of the subjective decision criteria caused by an experiential difference among engineers, one unified objective decision criteria may be provided so that failure may be decided based on the same criteria. Further, in general, engineers manually perform data pre-processing works, such as data collection and outlier removal, which require a lot of time, based on a simple statistical logic. However, according to an exemplary embodiment of the inventive concept, all processes including the data preprocessing process, statistical equivalence test and the final decision can be automatically performed as well as a function of automatically reporting the failure, so that failure and variation may be detected in an early stage and system consistency may be maximized.

While the inventive concept has been described with reference to exemplary embodiments thereof, it will be apparent to those of ordinary skill in the art that various changes and modifications may be made thereto without departing from the spirit and scope of the present inventive concept as defined by the following claims.

What is claimed is:

1. A method of performing a statistical equivalence test, the method comprising:
first deciding if process data has equivalence, non-equivalence or improvement by comparing a statistical value of the process data with a criteria statistical value;
correcting the criteria statistical value using a statistical tolerance for the process data that has the non-equivalence or improvement; and
second deciding if the process data that has the non-equivalence or improvement has acceptance or non-equivalence by comparing the process data that has the non-equivalence or improvement with the corrected criteria statistical value.

2. The method of claim 1, wherein the corrected criteria statistical value for the process data with the non-equivalence is obtained by following equations;
$${Criteria}_{Avg \text{-} non} = \frac{Max [ {\{ CI of ( {X}_{R} - {X}_{C \text{-} non} ) \}}^{2} ]}{Min ( {σ}_{R}^{2} , {σ}_{C \text{-} non}^{2} )}$$
$${Criteria}_{Var \text{-} non} = \frac{Max ( {σ}_{R}^{2} , {σ}_{C \text{-} non}^{2} )}{Min ( {σ}_{R}^{2} , {σ}_{C \text{-} non}^{2} )}$$
wherein CI denotes a confidence interval, X_{R} is an average value of a reference process data group, X_{C-nom} is an average value of a non-equivalence decided process data group, σ_{R}² is a standard deviation of the reference process data group, and σ_{C-nom}¹ is a standard deviation of the non-equivalence decided process data group.

3. The method of claim 1, wherein the corrected criteria statistical value for the process data with the improvement is obtained by following equations:
$${Criteria}_{Avg \text{-} imp} = \frac{Max [ {\{ CI of ( {X}_{R} - {X}_{C \text{-} imp} ) \}}^{2} ]}{{σ}_{R}^{2}}$$
$${Criteria}_{Var \text{-} imp} = \frac{{σ}_{C \text{-} imp}^{2}}{{σ}_{R}^{2}}$$
wherein CI denotes a confidence interval, X_{R} is an average value of a reference process data group, X_{C-imp} is an average value of an improvement decided process data group, and σ_{C-imp}² is a standard deviation of the improvement decided process data group.

4. The method of claim 1, further comprising:
third deciding if the process data that has the non-equivalence after the second deciding has acceptance or non-equivalence using an experiential technical tolerance of an engineer; and
fourth deciding final equivalence of the process data based on the first to third decision results.

5. The method of claim 1, wherein the process data have normal distribution/non-normal distribution, bounded data distribution/unbounded data distribution or a censored data distribution.

6. The method of claim 5, wherein the statistical value of the process data is calculated according the data distribution.

7. The method of claim 6, wherein the calculated statistical value is tested through an inference estimation scheme.

8. The method of claim 1, wherein the process data has improvement under following conditions:
a) if the statistical value of the non-equivalence decided process data is closer to a target value than to the criteria statistical value,
b) if the statistical value of the non-equivalence decided process data is less than the criteria statistical value when a smaller statistical value of the non-equivalence decided process data is better, or
c) if the statistical value of the non-equivalence decided process data is greater than the criteria statistical value when a greater statistical value of the non-equivalence decided process data is better.

9. The method of claim 1, wherein the process data are collected in a database according to a process variable.

10. The method of claim 9, wherein the collected process data are filtered for equivalence, consistency and traceability.

11. The method of claim 10, wherein the filtered process data are classified according to data characteristics.

12. The method of claim 11, wherein the data characteristics include quantification/attribute, real number/integer/percentage or row/summary.

13. The method of claim 11, wherein the classified process data are modeled in a statistical process model to remove abnormal values from the classified process data.

14. A system for testing statistical equivalence, the system comprising:
a storing unit configured to store a reference statistical value according to a process variable and data characteristics and engineer experience information;
an input unit configured to receive process data from at least one process equipment; and
a decision unit configured to determine statistical equivalence by comparing the received process data with the reference statistical value by:
first deciding if the received process data has equivalence, non-equivalence or improvement by comparing statistics of the received process data with reference statistics;
correcting the reference statistics using a statistical tolerance for the process data that has the non-equivalence or improvement;
second deciding if the process data that has the non-equivalence or improvement has acceptance or non-equivalence by comparing the process data that has the non-equivalence or improvement with the corrected reference statistics;
third deciding if the process data that has the non-equivalence after the second deciding has acceptance or non-equivalence using an experiential technical tolerance of an engineer; and
fourth deciding final equivalence of the process data based on the first to third decision results.

15. The system of claim 14, wherein the input unit collects and filters the received process data according to the process variable, classifies the received process data according to the data characteristics, and models the received process data on a statistical process model to remove abnormal values from the classified process data.

16. A method of performing a statistical equivalence test, the method comprising:
first determining if process data has non-equivalence or improvement based on a comparison of a statistical value of the process data to a statistical value of reference data;
adjusting the statistical value of the reference data; and
second determining if the process data has non-equivalence by comparing the process data with non-equivalence or improvement to the adjusted statistical value of the reference data.

17. The method of claim 16, wherein the process data is first determined to have non-equivalence when midranges of the process data and the reference data are not identical to each other, or a dispersion range of the process data is greater than that of the reference data.

18. The method of claim 17, wherein the process data is second determined to have non-equivalence when the midrange of the process data and adjusted midrange of the adjusted reference data are not identical to each other, or the dispersion range of the process data is not equivalent to that of the adjusted reference data.

19. The method of claim 16, further comprising third determining whether to admit the process data as equivalence or to process the process data as non-equivalence using an experiential and technical tolerance.

20. The method of claim 19, wherein the first to third determinings are automatically made.
